(19) United States
(12) Patent Application Publication
(10) Pub. No.: US 2026/0017465 A1
(43) Pub. Date: Jan. 15, 2026

(54) Identifying Exclusive Language Based on Context

(71) Applicant: Dell Products L.P., Round Rock, TX (US)

(72) Inventors: Shelly Goldblit, Haifa (IL); Michal Davidson, Beit Shemesh (IL); Yonit Lopatinski, Kiryat Gat (IL); Yaara Satmary, Kramim (IL); Merav Buchris, Beer Sheva (IL); Shira Salomon, Shim'a (IL); Anat Parush Tzur, Tel Aviv (IL)

(21) Appl. No.: 18/768,205

(22) Filed: Jul. 10, 2024

(51) Int. Cl. G06F 40/40; G06F 40/279; G06F 40/30

(52) U.S. Cl. CPC G06F 40/40; G06F 40/279; G06F 40/30

(57) ABSTRACT

A system can analyze first text that is received based on first user input data, and context of the first text, the analyzing using a large language model to identify a first recommendation to alter the first text to satisfy an inclusive-language criterion. The system can receive user feedback data based on the first recommendation. The system can tune the large language model based on the user feedback data, to produce an updated large language model. The system can analyze second text received based on second user input data with the updated large language model to identify a second recommendation to alter the second text to satisfy the inclusive-language criterion.

### BACKGROUND

Users can input text into a computer.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can analyze first text that is received based on first user input data, and context of the first text, the analyzing using a large language model to identify a first recommendation to alter the first text to satisfy an inclusive-language criterion. The system can receive user feedback data based on the first recommendation. The system can tune the large language model based on the user feedback data, to produce an updated large language model. The system can analyze second text received based on second user input data with the updated large language model to identify a second recommendation to alter the second text to satisfy the inclusive-language criterion.

An example method can comprise determining, by a large language model of a system comprising at least one processor, a first recommendation to alter first text to utilize more-inclusive language compared to the first text according to a defined inclusivity criterion, wherein the first text is received based on first user input data, and wherein the determining is based on a context of the first text. The method can further comprise receiving, by the system, user feedback data based on the first recommendation. The method can further comprise tuning, by the system, the large language model based on the user feedback data, to produce an updated large language model. The method can further comprise analyzing, by the system, second text received based on second user input data with the updated large language model to identify a second recommendation to alter the second text to utilize more-inclusive language.

An example non-transitory computer-readable medium can comprise instructions that, in response to execution, cause a system comprising a processor to perform operations. These operations can comprise providing a first recommendation to alter first text to utilize inclusive language, wherein the first text is received based on first user input data, wherein the first recommendation is determined with a large language model, and wherein the first recommendation is determined based on a context of the first text. Three operations can further comprise receiving, by the system, user feedback data based on the first recommendation. These operations can further comprise tuning, by the system, the large language model based on the user feedback data, to produce an updated large language model.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate identifying exclusive language based on context, in accordance with an embodiment of this disclosure;

FIG. 2 illustrates an example email user interface that can facilitate identifying exclusive language based on context, in accordance with an embodiment of this disclosure;

FIG. 3 illustrates an example job posting user interface that can facilitate identifying exclusive language based on context, in accordance with an embodiment of this disclosure;

FIG. 4 illustrates an example group collaboration user interface that can facilitate identifying exclusive language based on context, in accordance with an embodiment of this disclosure;

FIG. 5 illustrates an example process flow for continuous adjustments that can facilitate identifying exclusive language based on context, in accordance with an embodiment of this disclosure;

FIG. 6 illustrates an example of user feedback collection that can facilitate identifying exclusive language based on context, in accordance with an embodiment of this disclosure;

FIG. 7 illustrates another example system architecture that can facilitate identifying exclusive language based on context, in accordance with an embodiment of this disclosure;

FIG. 8 illustrates an example process flow that can facilitate identifying exclusive language based on context, in accordance with an embodiment of this disclosure;

FIG. 9 illustrates another example process flow that can facilitate identifying exclusive language based on context, in accordance with an embodiment of this disclosure;

FIG. 10 illustrates another example process flow that can facilitate identifying exclusive language based on context, in accordance with an embodiment of this disclosure;

FIG. 11 illustrates an example block diagram of a computer operable to execute an embodiment of this disclosure.

### DETAILED DESCRIPTION

### Overview

In some examples, the present technique can be implemented in a tool that identifies exclusive language and suggests replacing it with inclusive language. It can be integrated with organizational communication tools, while collecting user feedback for continues adjustments.

In some examples, the present techniques support customization to meet an organization's specific values and accommodate to linguistic pejoration and melioration to continuously adjust a large language model (LLM).

Exclusive language can hurt and alienate people, making them feel rejected, feel not part of the team, and even cause attrition.

As language constantly adapts and changes to reflect changing lives, experiences, and cultures, the present techniques can be implemented with linguistic pejoration and melioration (that is, semantic drift). Pejoration can comprise semantic drift where an inoffensive word becomes pejorative.

Studies have shown that diversity and inclusion can have an impact on financial performance. It can be that organizations with diversity are likely to be more profitable than their peers.

Inclusive language can avoid biases words that imply discrimination, while acknowledging diversity, conveying respect, and being sensitive to differences.

A challenge can be that many people do not use exclusive language on purpose. Rather, it can be that biases in exclusive language are subtle and non-deliberate. But it can still hurt.

Inclusive language can lead to a better, more productive, and more profitable workplace.

Non-inclusive language can cause excluded groups to be less likely to apply, advance, or ascend to leadership roles

A problem addressed by the present techniques can be, on a diverse workplace, how can exclusive language be reduced while continuously adjusting the organizational communication to an organization's specific values, and linguistic pejoration and melioration?

It can be that prior approaches support only a single platform, and let many problematic terms fly under the radar since they are not artificial intelligence (AI) based and do not take context into account. For instance, master can be an offensive term, however listing “master's degree” as a job requirement can be fine.

Furthermore, it can be that prior approaches do not collect user feedback to constantly adjust the model, thus being behind a current state of actual diverse language, which can continually evolve.

### Prerequisites

The present techniques can be implemented in conjunction with LLMs that can be continuously customized using model fine-tuning techniques.

In some examples, the present techniques can be implemented with a natural language processing (NLP) based plugin to mark non-inclusive language across the board.

Such an inclusivity check NLP plugin can identify problematic exclusive language, for instance language excluding certain gender identities, or language with negative bias against certain groups. The plugin can instead suggest more inclusive replacement terms.

Initial model tuning can be implemented as follows. An initial setting can be composed of two steps. A first step can comprise collecting a set of verified examples as described below.

$${\sum }_{i = 1}^{N} \begin{matrix}Provide an exclusive language input and \\ a corresponding expected inclusive language output per input\end{matrix}$$

An available initial set of verified examples can be leveraged to refine at least one LLM that specializes in text classification and text-to-text generation to address specific needs and requirements of an organization that utilizes the present techniques.

A second step can comprise using prompt engineering and fine-tuning approaches. To fine tune a model, there can be a need for dozens of tuning examples (10-100). In some examples, for this task, one can use a low-rank adaptation of LLM (LoRA) model, or a model with available tuning options.

In some examples, tuning can be skipped in the initial model, and used later on, once a sufficient number of verified examples have been collected in the continuance usage of the tool.

A prompt can be determined to get satisfactory results from the models. This can be done by defining a multi shot prompt that contains a description of the intent and the required output as well as some verified examples. Then, exclusive input can be concatenated. This prompt can be fed to the model and the response can be evaluated. The prompt can be adjusted iteratively until a desired response is achieved.

Once the prompt is ready, initial usage can begin, where each new user input can be concatenated to the defined prompt, and then fed to the model to receive an inclusive language suggestion (where one is identified).

The present techniques can be implemented to facilitate continuous adjustment for pejoration and melioration (drift), while considering a full context of the language. In other words, the present techniques are not a simple dictionary check, but rather can provide an examination of the context of word usage.

For example, it can be that the term “courageous leader” is not exclusive. However, it can be that usage of the term within a job listing can be exclusive due to context and gender bias.

The present techniques can be implemented to facilitate a continuous adjusting LLM-based plugin for inclusive communication for a unified experience across multiple communication platforms support customization to meet an organization's specific values to continuously adjust the LLM model. This can involve:

Collecting input across diverse perspectives on biased terms and incorporating that input in automated recommendations, thus creating a broader and more diverse model of an inclusive language.

Collecting continuous user feedback to better identify ever-changing exclusive language over time, and constantly adjusting to keep up with the evolvement of language.

Using inclusive language can demonstrate an organizational commitment to diversity, equity, and inclusion (DEI), and can reinforce diversity, inclusion and belonging as core values central to an organization's culture. It can also reduce discrimination and bias by actively discouraging exclusionary language and conduct. Because it can tend to improve communication and collaboration, inclusive language can break down barriers, building trust and mutual respect among colleagues.

By speaking with an inclusive voice in external communications (e.g., customer facing service representatives), organizations can experience an improvement in their reputation and the perception of their brand.

In some examples, a pre-trained LLM can be used as a starting point for implementing the present techniques. Then, the pre-trained model can be tuned to specific inclusive language examples, as described herein. This can save effort in training a LLM model.

In some examples, a context in which text is entered can be considered in determining whether to recommend more-inclusive language. For example, the term “code-ninja” in a job posting could sound intimidating for under-represented communities, while it could sound great in a yearly review.

The present techniques can be implemented to facilitate a feedback loop in tuning a LLM that provides inclusive language recommendations, where this feedback loop can enable multiple organizations to each fine-tune the LLM to their own organizational values and standards. Additionally, the feedback loop can mitigate against an issue of semantic drift, where the meaning of a word or phrase can change over time.

### Example Architectures, Etc

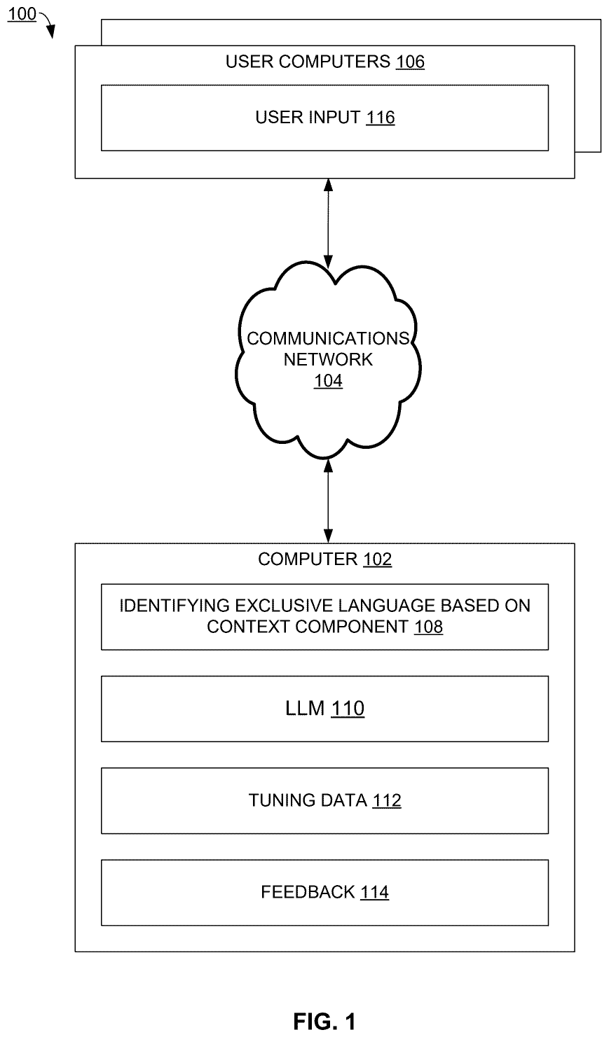

FIG. 1 illustrates an example system architecture 100 that can facilitate identifying exclusive language based on context, in accordance with an embodiment of this disclosure.

System architecture 100 comprises computer 102, communications network 104, and user computers 106. In turn, computer 102 comprises identifying exclusive language based on context component 108, LLM 110, tuning data 112, and feedback 114. And user computers 106 comprises user input 116.

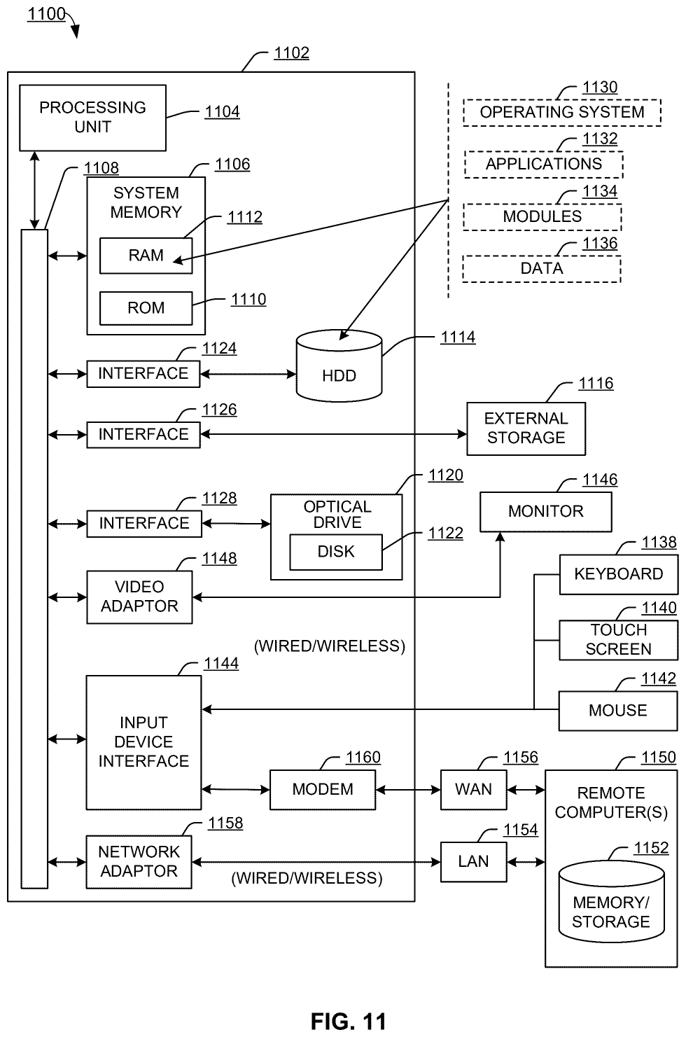

Each of computer 102 and/or user computers 106 can be implemented with part(s) of computing environment 1100 of FIG. 11. Communications network 104 can comprise a computer communications network, such as the Internet, or an isolated private computer communications network.

User computers 106 can comprise one or more computers at which users can input text data (e.g., to a word processor or an email program) as user input 116. User computers 106 can be communicatively coupled to computer 102 via communications network 104. Computer 102 can receive user input 116, and identifying exclusive language based on context component 108 can facilitate checking this user input for occurrences where more-inclusive language can be substituted, and making that suggestion to user computers 106.

For example, identifying exclusive language based on context component 108 can pass user input 116 through LLM 110, which can output a recommendation of more-inclusive language (where one is identified). A user of user computers 106 can receive this recommendation and provide feedback (e.g., feedback indicating that the recommendation is helpful, or that it is not helpful).

LLM 110 can be tuned with tuning data 112. In some examples, this can comprise supervised learning where tuning data 112 comprises pairs of an example input and an example output that is desired from LLM 110. LLM can also be iteratively tuned, such as periodically tuning LLM 110 with updated feedback 114. In some examples, feedback 114 can be collective feedback from multiple users, (e.g., “90% of users provided feedback that recommendation X to input Y is helpful.”).

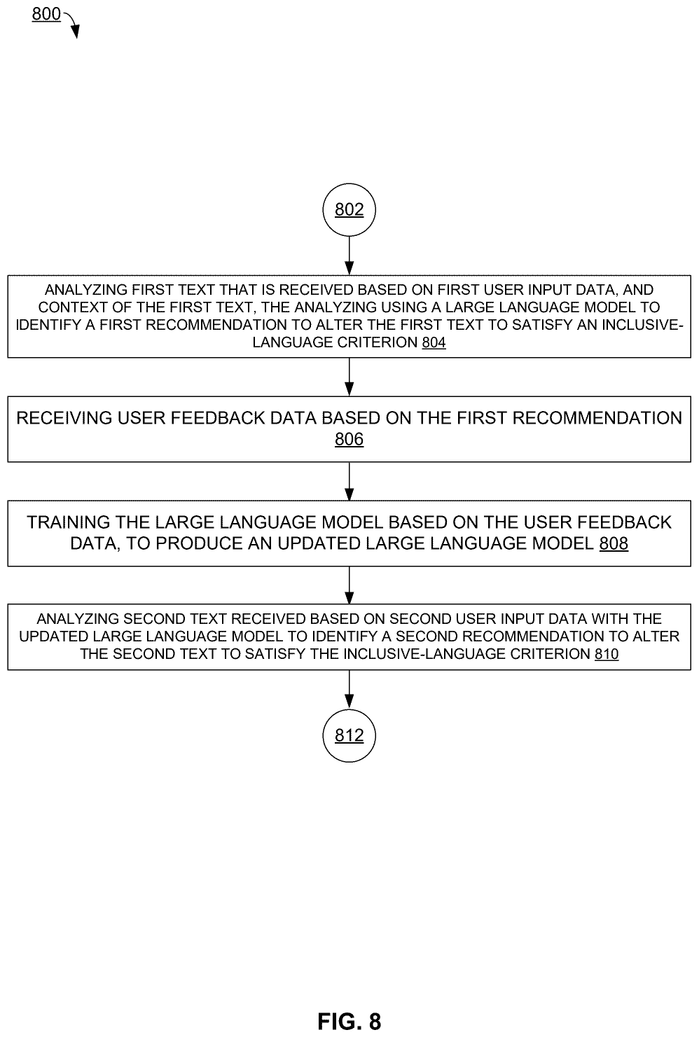

In some examples, identifying exclusive language based on context component 108 can implement part(s) of the process flows of FIGS. 8-10 to facilitate identifying exclusive language based on context.

It can be appreciated that system architecture 100 is one example system architecture for identifying exclusive language based on context, and that there can be other system architectures that facilitate identifying exclusive language based on context.

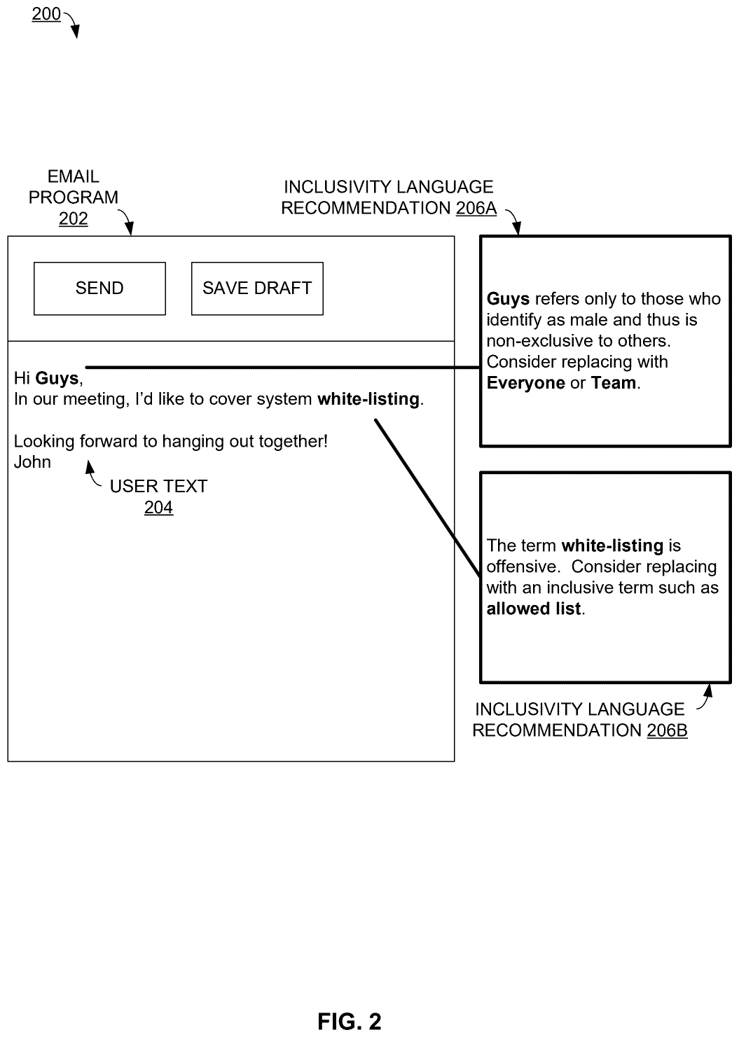

FIG. 2 illustrates an example email user interface 200 that can facilitate identifying exclusive language based on context, in accordance with an embodiment of this disclosure. In some examples, part(s) of email user interface 200 can be used to implement part(s) of system architecture 100 of FIG. 1.

Email user interface 200 comprises email program 202, user text 204, inclusivity language recommendation 206A, and inclusivity language recommendation 206B.

As a user inputs user text 204 into email program 202 to draft an email, an inclusivity check can be performed, and where more inclusive language is identified, this can be recommended to the user (as inclusivity language recommendation 206A and inclusivity language recommendation 206B). In some examples, recommendations can be provided to a user as the user types. In other examples, recommendations can be made after indicated by the user, such as by the user pressing a user interface button to perform an inclusivity check.

In some examples, there can be a user interface element to accept the recommendation and have user text 204 modified to incorporate it, such as via an ACCEPT button that is part of inclusivity language recommendation 206A or inclusivity language recommendation 206B.

An email program can be a form of customer-facing communication by an organization. Customer facing communication can be handled as follows. In such communications, problematic exclusive language can be identified—for instance, language excluding certain gender identities, or language with a negative bias against certain groups. Instead, more inclusive replacement terms can be suggested.

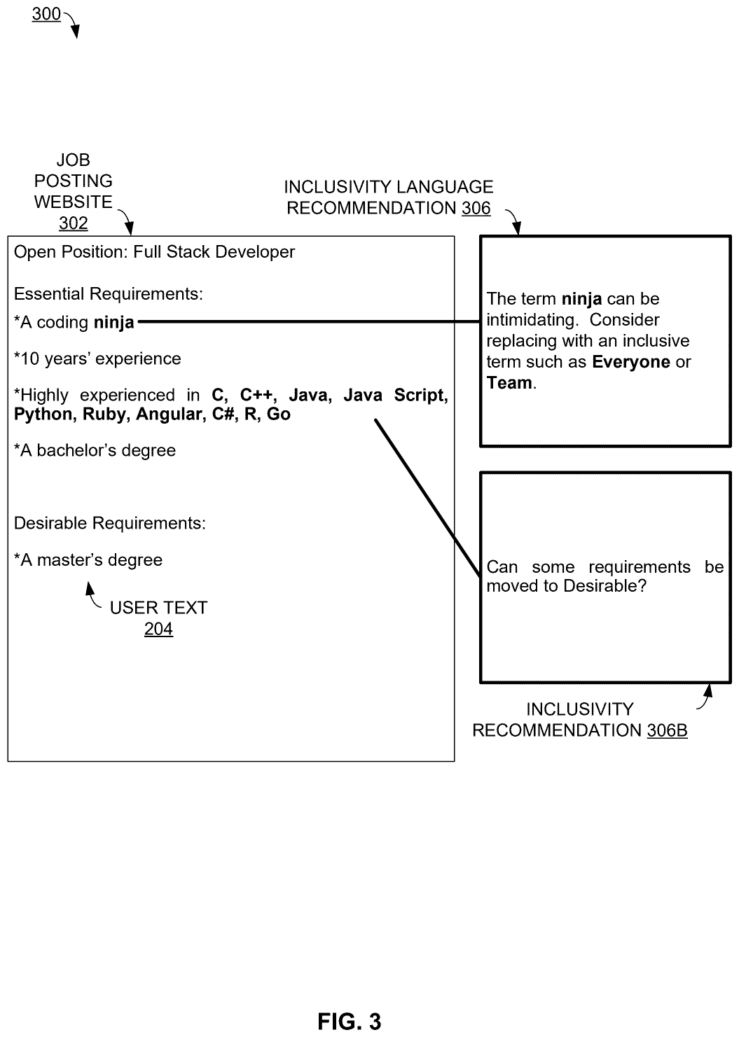

FIG. 3 illustrates an example job posting user interface 300 that can facilitate identifying exclusive language based on context, in accordance with an embodiment of this disclosure. In some examples, part(s) of job posting user interface 300 can be used to implement part(s) of system architecture 100 of FIG. 1.

Job posting user interface 300 comprises job posting website 302, user text 304, inclusivity language recommendation 306A, and inclusivity recommendation 308B.

In some examples, the present techniques can be implemented to make an inclusivity recommendation that is not strictly about language. For example, inclusivity recommendation 308B is related to identifying skills that could be listed in a job posting as “desired” rather than “essential.”

Job postings can be handled as follows. It can be that language in job posting can make applicants feel alienated from certain positions. It can be that they do not apply for them or have lower confidence in their abilities during the interview, even if they are well-qualified.

The present techniques can be implemented to automatically identify exclusive language in job postings and suggest replacing that language with language that is encouraging and welcoming.

The present techniques can take into account the full context—for example, it can be that the term “courageous leader” is great during a yearly review, but can be discouraging in a job posting.

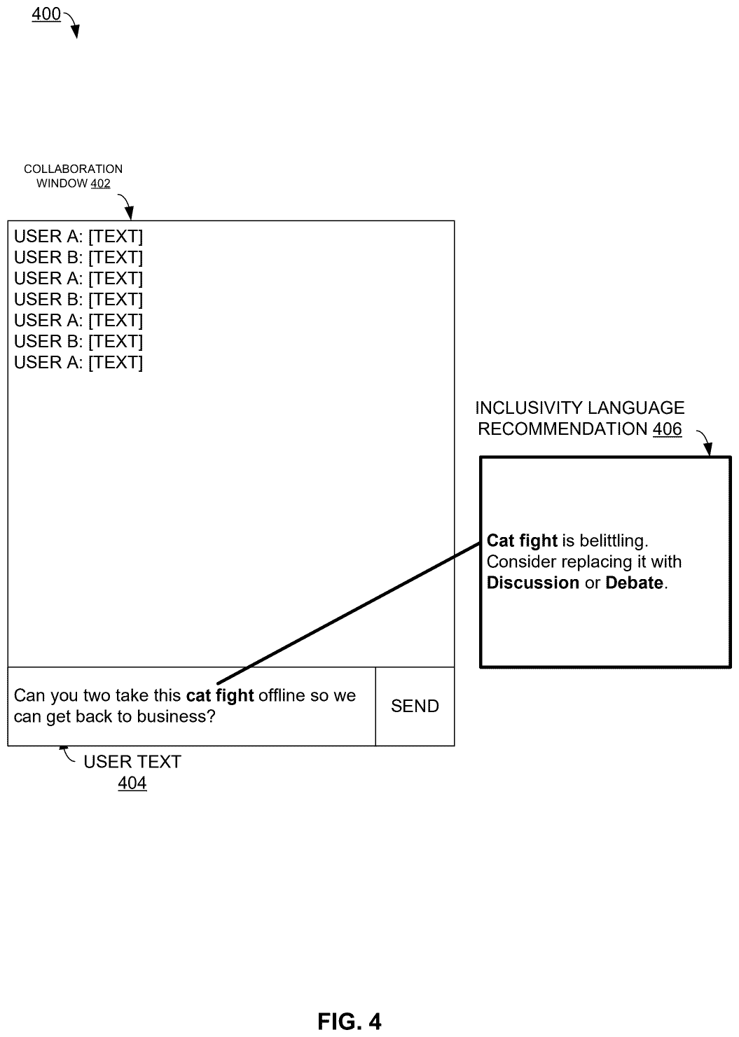

FIG. 4 illustrates an example group collaboration user interface 400 that can facilitate identifying exclusive language based on context, in accordance with an embodiment of this disclosure. In some examples, part(s) of example group collaboration user interface 400 can be used to implement part(s) of system architecture 100 of FIG. 1.

Group collaboration user interface 400 comprises collaboration window 402, user text 404, and inclusivity language recommendation 406.

Intra organizational communication can be handled as follows. Intra organizational communication can be monitored, to identify hurtful language that can be harmful and offensive to individuals and groups targeted by it, which can demotivate them, and cause attrition.

By flagging potentially harmful language, the present techniques can help reduce harm caused by language that may be hurtful (often unintentionally so).

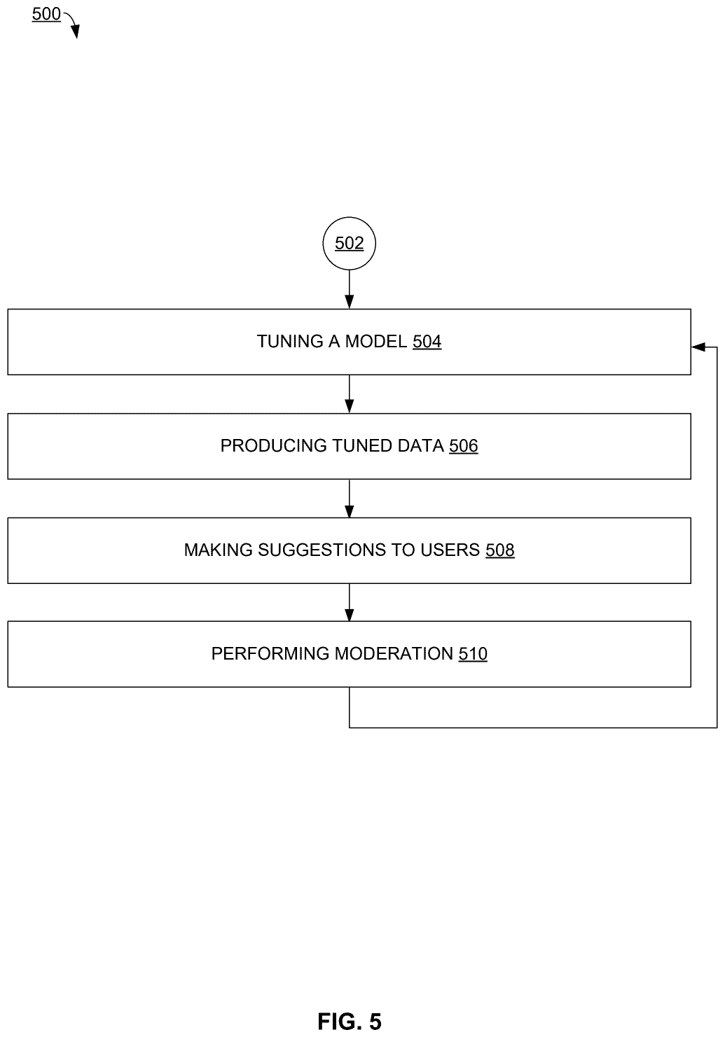

FIG. 5 illustrates an example process flow 500 for continuous adjustments that can facilitate identifying exclusive language based on context, in accordance with an embodiment of this disclosure. In some examples, one or more embodiments of process flow 500 can be implemented by system architecture 100 of FIG. 1, or computing environment 1100 of FIG. 11.

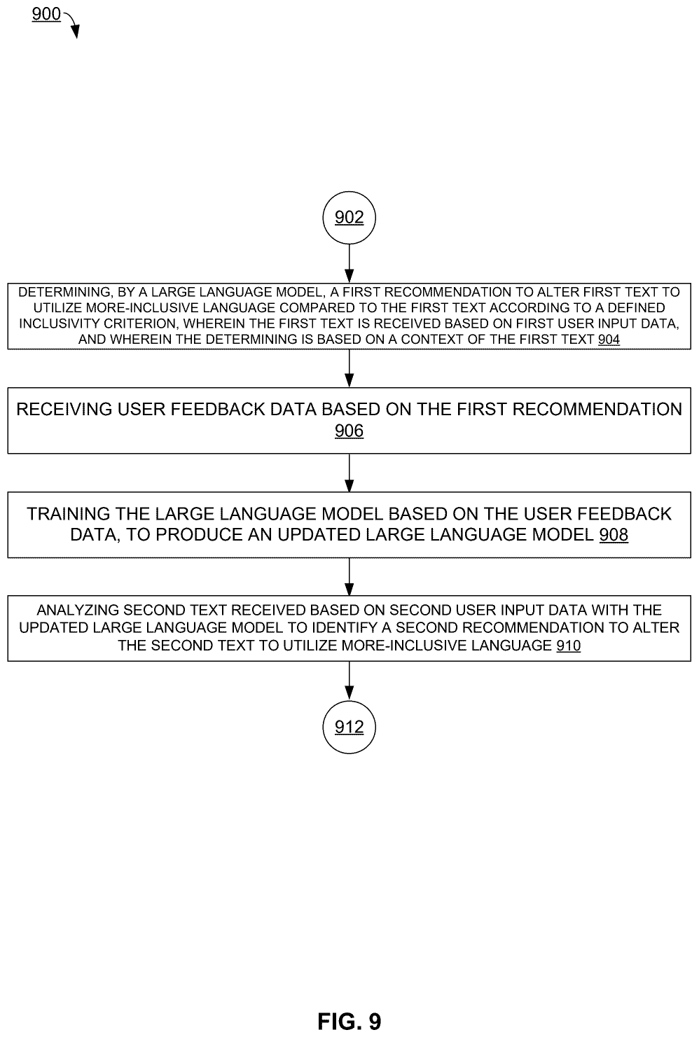

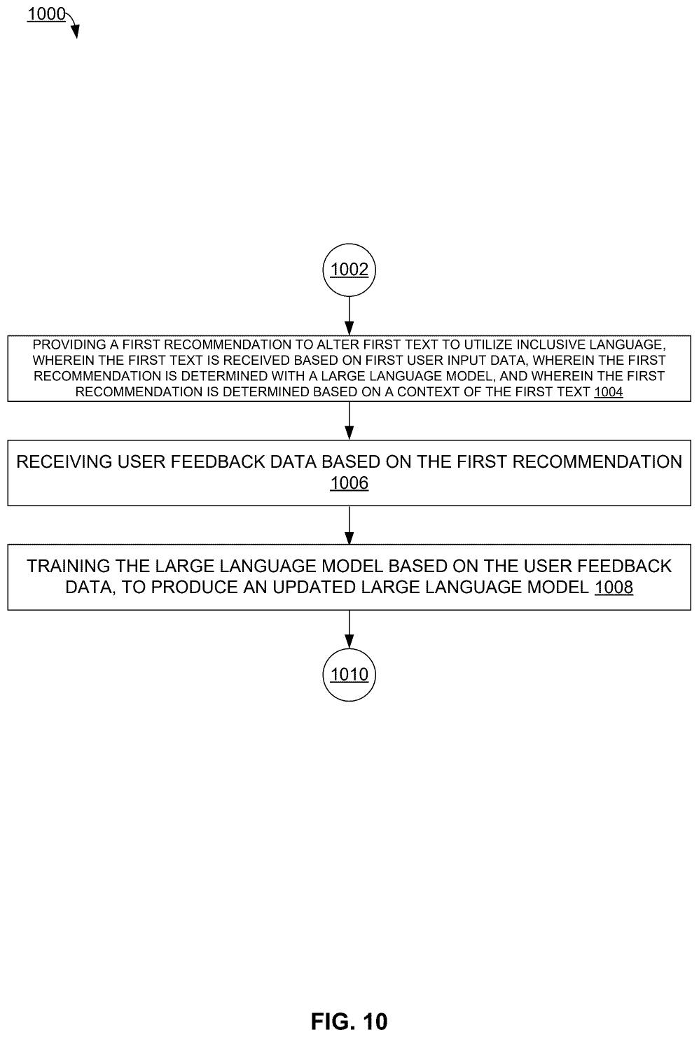

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 800 of FIG. 8, process flow 900 of FIG. 9, and/or process flow 1000 of FIG. 10.

Process flow 500 begins with 502, and moves to operation 504.

Operation 504 comprises tuning a model. This can be a LLM model like LLM 110 of FIG. 5.

After operation 504, process flow 500 moves to operation 506.

Operation 506 comprises producing tuned data. This can be an output of the tuned model of operation 504 and can comprise pairs of input text and more-inclusive recommendations.

After operation 506, process flow 500 moves to operation 508.

Operation 508 comprises making suggestions to users. As users input text, the tuned data of operation 506 can be used to make suggestions of how to use more-inclusive language in that text.

After operation 508, process flow 500 moves to operation 510.

Operation 510 comprises performing moderation. As users receive suggestions in operation 508, they can provide feedback as to whether those suggestions are helpful or good. This can be received by moderators, which can approve or decline changing the suggestions that will be offered based on the feedback. This moderation can be supplied to operation 504 to further tune the model. In this manner, loops of operation 504-510 can be performed to iteratively tune an LLM, and provide recommendations with a currently-updated LLM.

After operation 510, process flow 500 moves to operation 504.

Continuous adjustments can be implemented as follows. User feedback and suggestions can be collected to be used for continuously adjusting a LLM model.

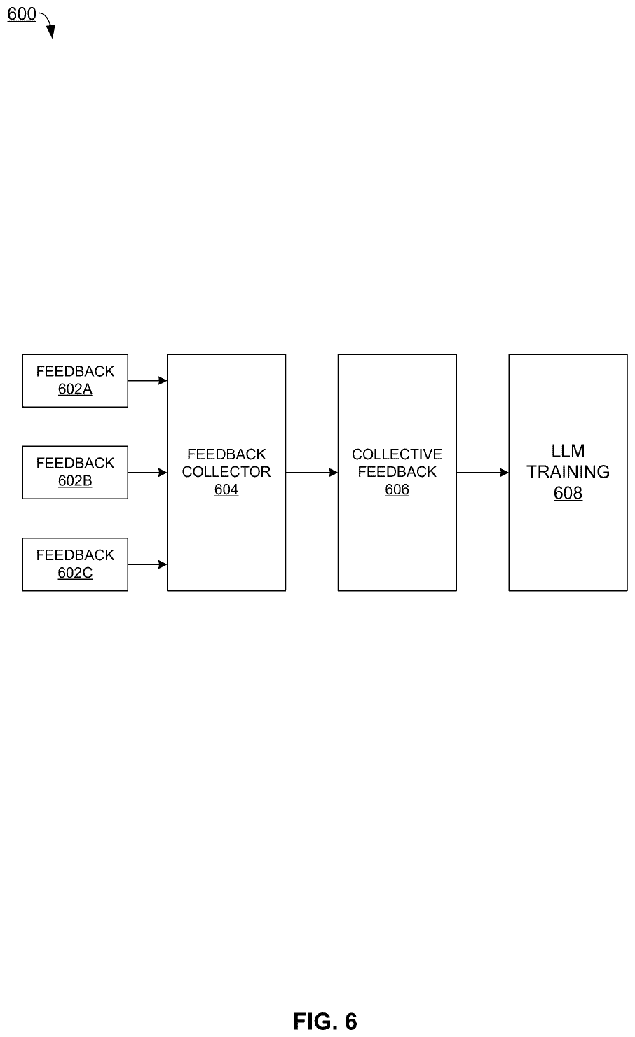

FIG. 6 illustrates an example 600 of user feedback collection that can facilitate identifying exclusive language based on context, in accordance with an embodiment of this disclosure. In some examples, part(s) of example 600 can be used to implement part(s) of system architecture 100 of FIG. 1.

Example 600 comprises feedback 602A, feedback 602B, feedback 602C, feedback collector 604, collective feedback 606, and LLM tuning 608.

The present techniques can be implemented to perform fine tuning by leveraging feedback from users, thus allowing fast adjustments. Collected feedback can be moderated in collaboration with a culture, diversity and inclusion team (or the like).

Furthermore, data collected based on user preference (e.g., to accept or reject a recommendation) can be used to validate, adapt, and present the information to moderators in a cumulative form, such as, 90% of users find the term “whitelist” exclusive. This can be used as data for a recommendation system to further assist moderators in making an informed decision when applying a customization/change. Thus, this can facilitate an effective and data-driven decision-making based on a wide view of inclusivity fused from multiples users' perspectives.

It can be that even well-tuned models cannot identify all exclusive terms, so collecting feedback from users to be later implemented into a LLM model (pending moderation) can ensure a plugin according to the present techniques will continuously improve, and be fine-tuned to the organization's values.

For example, the sentence, “wives are welcome to join” could be inclusive as it can suggest that women are not employees, as well as discriminate against same-sex couples.

Continuous LLM refinement for user adjustments can be implemented as follows. When using a tuned LLM, multi-shot prompts can be used.

An existing collection N (of i=1 to N Exclusive input->Inclusive outputs) can be adjusted (e.g., based on moderator recommendations and previous user inputs) and updated offline in order to refine the recommendations.

This updated collection can then be input to the LLM.

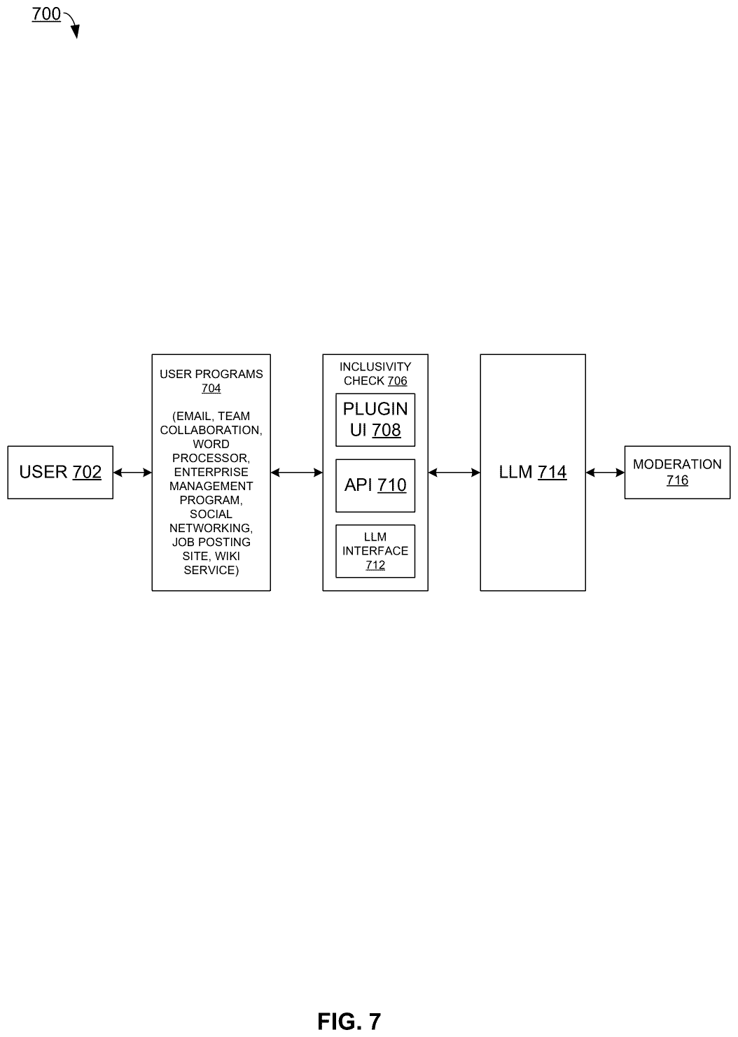

FIG. 7 illustrates another example system architecture 700 that can facilitate identifying exclusive language based on context, in accordance with an embodiment of this disclosure. In some examples, part(s) of example system architecture 700 can be used to implement part(s) of system architecture 100 of FIG. 1.

System architecture 700 comprises user 702, user programs 704 (email, team collaboration, word processor, enterprise management program, social networking, job posting site, wiki service), inclusivity check 706, plugin user interface (UI) 708, application programming interface (API) 710, LLM interface 712, LLM 714, and moderation 716.

An example architecture that implements the present techniques can be as follows. Users can interact with a plugin that implements the present techniques in a communication channel/tool. The text from the user can be sent for analysis using an application programming interface (API), and the results (recommendations) can be displayed to the user. The user's action can then be whether to accept or reject the recommendations, which can also be sent for analysis as labeled data, and used in tuning a supervised learning model.

User suggestions can be sent to the moderators, so they can decide whether to accept or reject the suggestions. The moderator can make an informed decision based on data collected from previous user actions.

Once a suggestions batch is accepted, the model can adapt to this batch by performing model tuning. Thus, futures usage can incorporate those adjustments and provide up-to-date feedback. LLM fine-tuning techniques can guarantee that even a batch of dozens of suggestions can make an impact on model output.

### Example Process Flows

FIG. 8 illustrates an example process flow 800 for identifying exclusive language based on context, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 900 of FIG. 9, and/or process flow 1000 of FIG. 10.

Process flow 800 begins with 802, and moves to operation 804.

Operation 804 depicts analyzing first text that is received based on first user input data, and context of the first text, the analyzing using a large language model to identify a first recommendation to alter the first text to satisfy an inclusive-language criterion. That is, a user can type something, and a LLM can determine that more-inclusive language than what the user typed can be used instead. In doing so, the LLM can consider a context in which the text is expressed. For example, one phrase (e.g., code ninja) could be considered inappropriate (or a candidate for using more-inclusive language) in a job posting context, while being considered to be appropriate in an annual review context.

In some examples, operation 804 comprises, before analyzing the first text that is received based on the first user input data with the large language model, tuning the large language model with a group of pairs, wherein respective pairs of the group of pairs comprise respective exclusive language examples and corresponding expected inclusive language examples. In some examples, the large language model is tuned to specialize in text classification or text-to-text generation. That is, an available initial set of verified examples can be leveraged to refine an existing LLM, which can specialize in text classification and/or text2text generation to address the specific needs and requirements of an organization.

In some examples, operation 804 comprises after tuning the large language model with the group of pairs, tuning the model with a low-rank adaptation of a defined large language models process. That is, prompt engineering and fine-tuning approaches can be used. To fine tune a model, there can be tuning examples (e.g., 10-100), and LoRA or models with available tuning options can be used for this.

In some examples, operation 804 comprises, before analyzing the first text that is received based on the first user input data with the large language model, tuning the large language model via providing a multi-shot prompt as input to the large language model, wherein the multi-shot prompt comprises a description of an intent to suggest inclusive language and an output that is to be output by the large language model. That is, a prompt can be developed to get satisfactory results from the models. This can be accomplished by defining a multi shot prompt that contains a description of the intent and the required output, as well as some verified examples. Then, exclusive input can be concatenated. This prompt can be fed to the model and the response can be evaluated. The prompt can be adjusted iteratively until the desired response is achieved.

After operation 804, process flow 800 moves to operation 806.

Operation 806 depicts receiving user feedback data based on the first recommendation. That is, the user can provide feedback about whether the LLM's recommendation is good or bad.

After operation 806, process flow 800 moves to operation 808.

Operation 808 depicts tuning the large language model based on the user feedback data, to produce an updated large language model. That is, the LLM can be iteratively tuned on the feedback about its recommendations, to improve the LLM's recommendations.

In some examples, operation 808 comprises receiving moderator approval data that is indicative of the user feedback data being approved by a monitor before performing the tuning of the language model based on the user feedback data. In some examples, the moderator approval data indicates approval of cumulative user feedback data that comprises the user feedback data.

In some examples, the moderator approval data is first moderator approval data, the user feedback data is first user feedback data, and operation 808 comprises refraining from updating the large language model based on receiving second moderator approval data that is indicative of the second user feedback data being rejected.

That is, data collected based on a user's preference (e.g., to accept or reject recommendation) can be used to validate and adapt and present the information to the moderators in a cumulative form—e.g., 90% of users find the term “whitelist” exclusive. This can be used as data for a recommendation system to further assist moderators in making an informed decision when applying a customization/change. Thus, this can allow an effective and data-driven decision making based on a wide view of inclusivity fused from multiples users' perspectives.

In some examples, the tuning of the large language model is performed based on the receiving of the moderator approval data. That is, a moderator can make an informed decision based on data collected from previous users' actions. Once a suggestions batch is accepted, a model can adapt to this batch by performing model tuning.

After operation 808, process flow 800 moves to operation 810.

Operation 810 depicts analyzing second text received based on second user input data with the updated large language model to identify a second recommendation to alter the second text to satisfy the inclusive-language criterion. That is, the updated LLM of operation 808 can then be used to provide recommendations to users.

After operation 810, process flow 800 moves to 812, where process flow 800 ends.

FIG. 9 illustrates an example process flow 900 for identifying exclusive language based on context, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 800 of FIG. 8, and/or process flow 1000 of FIG. 10.

Process flow 900 begins with 902, and moves to operation 904.

Operation 904 depicts determining, by a large language model, a first recommendation to alter first text to utilize more-inclusive language compared to the first text according to a defined inclusivity criterion, wherein the first text is received based on first user input data, and wherein the determining is based on a context of the first text. In some examples, operation 904 can be implemented in a similar manner as operation 804 of FIG. 8.

After operation 904, process flow 900 moves to operation 906.

Operation 906 depicts receiving user feedback data based on the first recommendation. In some examples, operation 906 can be implemented in a similar manner as operation 806 of FIG. 8.

After operation 906, process flow 900 moves to operation 908.

Operation 908 depicts tuning the large language model based on the user feedback data, to produce an updated large language model. In some examples, operation 908 can be implemented in a similar manner to operation 808 of FIG. 8.

In some examples, operation 1008 comprises iteratively updating the large language model based on a group of user feedback data that comprises the user feedback data. That is, a LLM can be refined over time.

In some examples, the large language model has been tuned on pairs comprising respective inputs and respective outputs, the respective inputs comprise respective examples of exclusive language, and the respective outputs comprise respective corresponding examples of inclusive language operation 908 comprises updating the pairs offline. In some examples, updating the pairs offline produces updated pairs, and the tuning of the large language model comprises inputting the updated pairs into the large language model. That is, an existing collection N (of i=1 to N exclusive input->inclusive outputs) can be adjusted (e.g., based on moderator recommendations and previous user inputs) and updated offline in order to refine the recommendations. This updated collection can then be input to the LLM.

After operation 908, process flow 900 moves to operation 910.

Operation 910 depicts analyzing second text received based on second user input data with the updated large language model to identify a second recommendation to alter the second text to utilize more-inclusive language. In some examples, operation 910 can be implemented in a similar manner as operation 810 of FIG. 8.

In some examples, operation 910 comprises providing the first recommendation via a plugin to an email program.

After operation 910, process flow 900 moves to 912, where process flow 900 ends.

FIG. 10 illustrates an example process flow 1000 for identifying exclusive language based on context, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 800 of FIG. 8, and/or process flow 900 of FIG. 9.

Process flow 1000 begins with 1002, and moves to operation 1004.

Operation 1004 depicts providing a first recommendation to alter first text to utilize inclusive language, wherein the first text is received based on first user input data, wherein the first recommendation is determined with a large language model, and wherein the first recommendation is determined based on a context of the first text. In some examples, operation 1004 can be implemented in a similar manner as operation 804 of FIG. 8.

After operation 1004, process flow 1000 moves to operation 1006.

Operation 1006 depicts receiving user feedback data based on the first recommendation. In some examples, operation 1006 can be implemented in a similar manner as operation 806 of FIG. 8.

After operation 1006, process flow 1000 moves to operation 1008.

Operation 1008 depicts tuning the large language model based on the user feedback data, to produce an updated large language model. In some examples, operation 1008 can be implemented in a similar manner as operation 808 of FIG. 8.

In some examples, operation 1008 comprises sending the first recommendation to be rendered via a word processor program.

In some examples, operation 1008 comprises sending the first recommendation to be rendered via a team collaboration application.

In some examples, operation 1008 comprises providing the first recommendation to be rendered via an enterprise management program.

In some examples, operation 1008 comprises sending the first recommendation to be rendered via an enterprise social networking service.

In some examples, operation 1008 comprises sending the first recommendation to be rendered via a wiki service.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of computer 102 and/or user computers 106 of FIG. 1.

In some examples, computing environment 1100 can implement one or more embodiments of the process flows of FIGS. 8-10 to facilitate identifying exclusive language based on context.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
analyzing first text that is received based on first user input data, and context of the first text, the analyzing using a large language model to identify a first recommendation to alter the first text to satisfy an inclusive-language criterion;
receiving user feedback data based on the first recommendation;
tuning the large language model based on the user feedback data, to produce an updated large language model; and
analyzing second text received based on second user input data with the updated large language model to identify a second recommendation to alter the second text to satisfy the inclusive-language criterion.

2. The system of claim 1, wherein the operations further comprise:
receiving moderator approval data that is indicative of the user feedback data being approved by a monitor before performing the tuning of the language model based on the user feedback data.

3. The system of claim 2, wherein the moderator approval data indicates approval of cumulative user feedback data that comprises the user feedback data.

4. The system of claim 2, wherein the moderator approval data is first moderator approval data, wherein the user feedback data is first user feedback data, and wherein the operations further comprise:
refraining from updating the large language model based on receiving second moderator approval data that is indicative of the second user feedback data being rejected.

5. The system of claim 2, wherein the tuning of the large language model is performed based on the receiving of the moderator approval data.

6. The system of claim 1, wherein the operations further comprise:
before analyzing the first text that is received based on the first user input data with the large language model, tuning the large language model with a group of pairs, wherein respective pairs of the group of pairs comprise respective exclusive language examples and corresponding expected inclusive language examples.

7. The system of claim 6, wherein the large language model is tuned to specialize in text classification or text-to-text generation.

8. The system of claim 6, wherein the operations further comprise:
after tuning the large language model with the group of pairs, tuning the model with a low-rank adaptation of a defined large language models process.

9. The system of claim 1, wherein the operations further comprise:
before analyzing the first text that is received based on the first user input data with the large language model, tuning the large language model via providing a multi-shot prompt as input to the large language model, wherein the multi-shot prompt comprises a description of an intent to suggest inclusive language and an output that is to be output by the large language model.

10. A method, comprising:
determining, by a large language model of a system comprising at least one processor, a first recommendation to alter first text to utilize more-inclusive language compared to the first text according to a defined inclusivity criterion, wherein the first text is received based on first user input data, and wherein the determining is based on a context of the first text;
receiving, by the system, user feedback data based on the first recommendation;
tuning, by the system, the large language model based on the user feedback data, to produce an updated large language model; and
analyzing, by the system, second text received based on second user input data with the updated large language model to identify a second recommendation to alter the second text to utilize more-inclusive language.

11. The method of claim 10, further comprising:
iteratively updating, by the system, the large language model based on a group of user feedback data that comprises the user feedback data.

12. The method of claim 10, further comprising:
providing, by the system, the first recommendation via a plugin to an email program.

13. The method of claim 10, wherein the large language model has been tuned on pairs comprising respective inputs and respective outputs, wherein the respective inputs comprise respective examples of exclusive language, and wherein the respective outputs comprise respective corresponding examples of inclusive language, and further comprising:
updating the pairs offline.

14. The method of claim 13, wherein updating the pairs offline produces updated pairs, and wherein the tuning of the large language model comprises:
inputting the updated pairs into the large language model.

15. A non-transitory computer-readable medium comprising instructions that, in response to execution, cause a system comprising at least one processor to perform operations, comprising:
providing a first recommendation to alter first text to utilize inclusive language, wherein the first text is received based on first user input data, wherein the first recommendation is determined with a large language model, and wherein the first recommendation is determined based on a context of the first text;
receiving, by the system, user feedback data based on the first recommendation; and
tuning, by the system, the large language model based on the user feedback data, to produce an updated large language model.

16. The non-transitory computer-readable medium of claim 11, further comprising:
sending, by the system, the first recommendation to be rendered via a word processor program.

17. The non-transitory computer-readable medium of claim 11, further comprising:
sending, by the system, the first recommendation to be rendered via a team collaboration application.

18. The non-transitory computer-readable medium of claim 11, further comprising:
providing, by the system, the first recommendation to be rendered via an enterprise management program.

19. The non-transitory computer-readable medium of claim 11, further comprising:
sending, by the system, the first recommendation to be rendered via an enterprise social networking service.

20. The non-transitory computer-readable medium of claim 11, further comprising:
sending, by the system, the first recommendation to be rendered via a wiki service.
